(19) United States
(12) Patent Application Publication
(10) Pub. No.: US 2021/0185526 A1
(43) Pub. Date: Jun. 17, 2021

(54) LOCATION BASED AUTHENTICATION

(71) Applicant: Hewlett-Packard Development Company, L.P., Spring, TX (US)

(72) Inventors: Gurchetan GREWAL, Bristol (GB); Joshua Serratelli SCHIFFMAN, Bristol (GB); Boris BALACHEFF, Meudon CEDEX (FR)

(73) Assignee: Hewlett-Packard Development Company, L.P., Spring, TX (US)

(21) Appl. No.: 16/759,037

(22) PCT Filed: Sep. 17, 2018
(86) PCT No.: PCT/US2018/051296

§ 371 Date: Apr. 24, 2020

(30) Foreign Application Priority Data
Oct. 30, 2017 (EP) 17306486.6

(51) Int. Cl. H04W 12/06; H04W 12/63; H04W 12/65; H04L 29/06; H04W 12/12

(52) U.S. Cl. CPC H04W 12/06; H04W 12/63; H04W 12/12; H04L 63/0807; H04W 12/65

(57) ABSTRACT

A method for location-based authentication of a device comprises receiving multiple device location fingerprints generated using respective ones of multiple device sensors, comparing the device location fingerprints with corresponding respective environment fingerprints generated using respective ones of multiple static sensors and generating a token for the device to authorise it to use one or more selected services.

### BACKGROUND

Password based authentication can be burdensome for users. Some authentication systems can leverage the use of location-based access control. This can be performed using GPS and/or wireless radio Received Signal Strength Indicator (RSSI) values for example. GPS is weak indoors and RSSI values are notoriously erratic and subject to spoofing. Moreover, providing specific location information may leak personally identifiable information.

### BRIEF DESCRIPTION OF THE DRAWINGS

Various features and advantages of certain examples will be apparent from the detailed description which follows, taken in conjunction with the accompanying drawings, which together illustrate, by way of example only, a number of features, and wherein:

FIG. 1 is a schematic representation of a system according to an example;

FIG. 2 is a schematic representation of a comparison apparatus according to an example;

FIG. 3 is a flowchart of a method according to an example; and

FIG. 4 shows an example of a processor associated with a memory according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

According to an example, there is provided a method and system that removes an authentication burden from users by automatically authenticating devices if they are present in a particular environment. For example, many internet of things (IoT) devices are equipped with sensors that can be used to collect an environmental fingerprint that can be used to provide a device location. Such location fingerprints can be used to match devices in the same general area and establish “co-presence.” In an example, a central hub based approach is described, in which the hub acts as a location fingerprint matching service among managed devices in an ad-hoc fashion. Unlike location based authentication, users do not need to pre-select a location where the authentication is not needed. Although the system works with a cloud service it can also work directly with local devices.

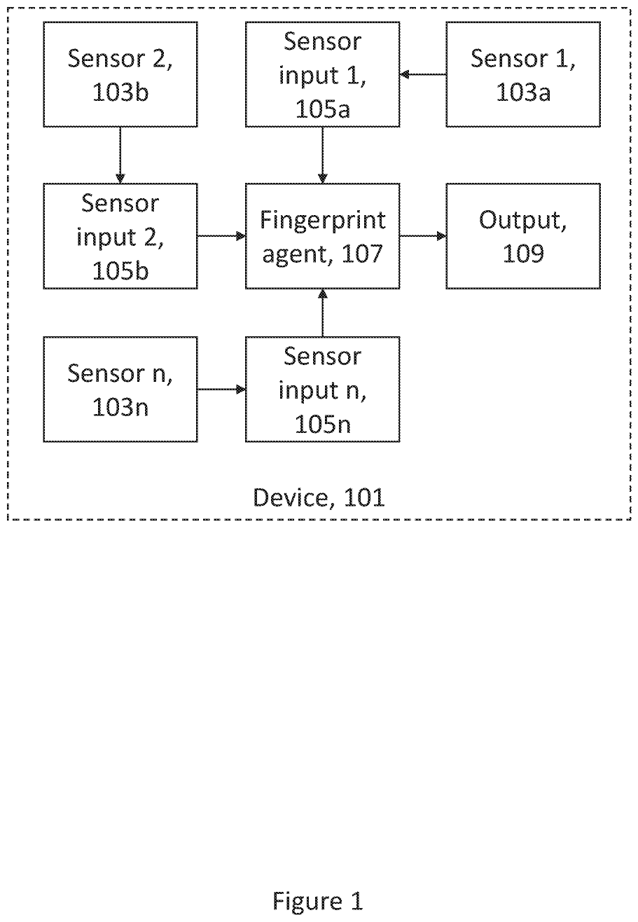

FIG. 1 is a schematic representation of a system according to an example. A device 101 comprises multiple sensors, 103a-n, each of which can generate a sensor input, 105a-n to a fingerprint agent 107 of the device 101. In an example, one or more of the sensors 103a-n can pass data to the fingerprint agent 107 representing respective measures for environmental characteristics. That is, each sensor 103a-n can generate data representing a value for an environmental characteristic local to the device 101. The data is provided to the agent 107 as multiple sensor inputs 105a-n. Fingerprint agent 107 can generate an output 109 that can be used to determine the location of the device 101, as will be described below in more detail. That is, each sensor 103a-n can be used to generate a measure representing a location fingerprint for a certain environmental characteristic. As such, device 101 can have a range of integrated sensors I connectors, such as networking interfaces, cameras, microphones, accelerometers, and so on, that can be used to generate the location fingerprints.

According to an example, sensors 103a-n can comprise one or more of the following:

Networking Interfaces: Network connectivity can provide a range of clues as to device 101 environment, Besides GeoIP, which is a form of geolocation that can determine a device's geographic location by identifying the device's IP address, tools and information such as ipconfig, tracert, ASN lookup and network ‘noise’ from broadcasts can give indications of the device's environment, and therefore its location. For example, a clear picture of environment can be determined from IP address, a local network access gateway to which the device is connected and other factors as to whether the device is connected to within an organisation's network, thereby providing a location fingerprint.

Cameras: Cameras can be activated to recognize a device environment directly. This can provide strong evidence of the environment. For example, machine learning and in particular image recognition can enable device 101 to use a camera to classify its environment into one of a handful of possibilities, such as ‘office’, ‘kitchen’, and so on, which can be used in the form of image data as a location fingerprint for example.

Sound: One or more built-in microphones can be used to help determine if two devices are in the same locality. For example, a decibel measure can be sued, giving indication of how busy the environment is. The measure can form a location fingerprint.

Temperature sensors: These sensors can measure the temperature of the environment which can be used as an additional measure of locality of devices. The measure can form a location fingerprint.

Hygrometer: These humidity sensors can measure the water vapors in the environment which can be used as an additional measure of locality of devices. The measure can form a location fingerprint.

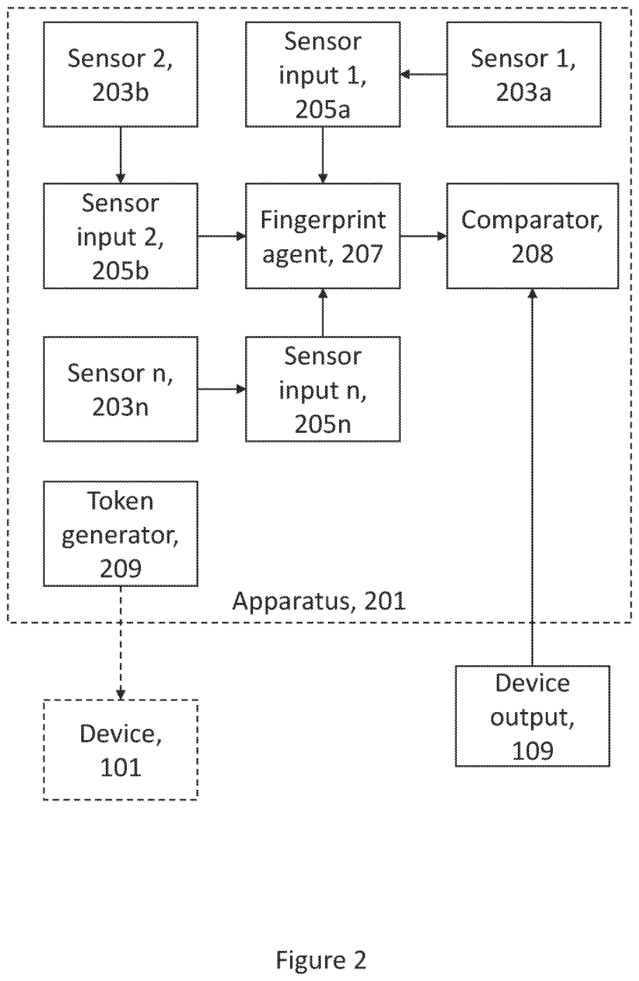

FIG. 2 is a schematic representation of a comparison apparatus according to an example. The comparison apparatus 201 can be in the form of a hub that takes input 205a-n from sensors 203a-n and uses this input to generate a set of fingerprints using an agent 207. It compares its own fingerprints generate using agent 207 with the fingerprints provided by external devices. For example, with reference to FIG. 1, output 109 from device 101 is received by comparator 208 of apparatus 201, which also receives data from agent 207 representing measures for one or more fingerprints generated using the sensors 203a-n of apparatus 201. The comparator 208 compares the fingerprints from agent 207 to those generated by the sensors 103a-n of device 101 using agent 107 in order to determine a measure of similarity between respective ones of the fingerprints. For example, a temperature measurement from device 101, forming a first location fingerprint of device 101 can be compared to a temperature measurement generated using one of the sensors 203a-n of apparatus 201. If the two measurements match, to within a predefined tolerance, such as +/−2 degrees for example, to account for fluctuations as result of slight positional differences of the device 101 and the apparatus 201 in the location in question, then the location of the device 101 can be said to be the same as the position of the apparatus 201.

According to an example, a fuzzy hashing scheme can be used for device authentication. For example, a device location fingerprint can be used to generate a random string (forming a symmetric key) using a fuzzy extractor, which may use a hash function for example. A keyed-hash message authentication code (HMAC) can be used to hash the string with a challenge received from the apparatus 201. The result (response) can be transmitted to the apparatus 201 can compared with a symmetric key generated at the apparatus using a corresponding location fingerprint derived at the apparatus 201. If the keys match, the device is in the same locale as the apparatus (since the keys are derived using location fingerprints). A similar process can be used to authenticate a device using entropy extraction to generate a key from a location fingerprint.

Once the locality has been established the apparatus 201 can provide a token to the device 101 that allows them access to certain resources or use certain services using a token generator 209. In an example, the apparatus 201 and the device 101 can periodically generate and compare signatures to make sure that the device 101 still satisfies any locality requirements for using the token. The example described with reference to FIGS. 1 and 2 concentrated on one device 101. However, apparatus 201 can communicate with multiple such devices in a given locality.

In some examples, the apparatus 201 can take the number of devices present in the locality into account as well to generate location fingerprints. This means that if a new device enters or leaves the locality the fingerprints are updated. This stops an attacker to steal the finger prints and provide it to a device that does not satisfy the locality conditions.

In an example, the apparatus 201 is a trusted comparison agent, whereby the authenticating device/user can trust the apparatus 201 not to reuse and thus impersonate the device. That is, the apparatus 201 is trusted to compare fingerprints.

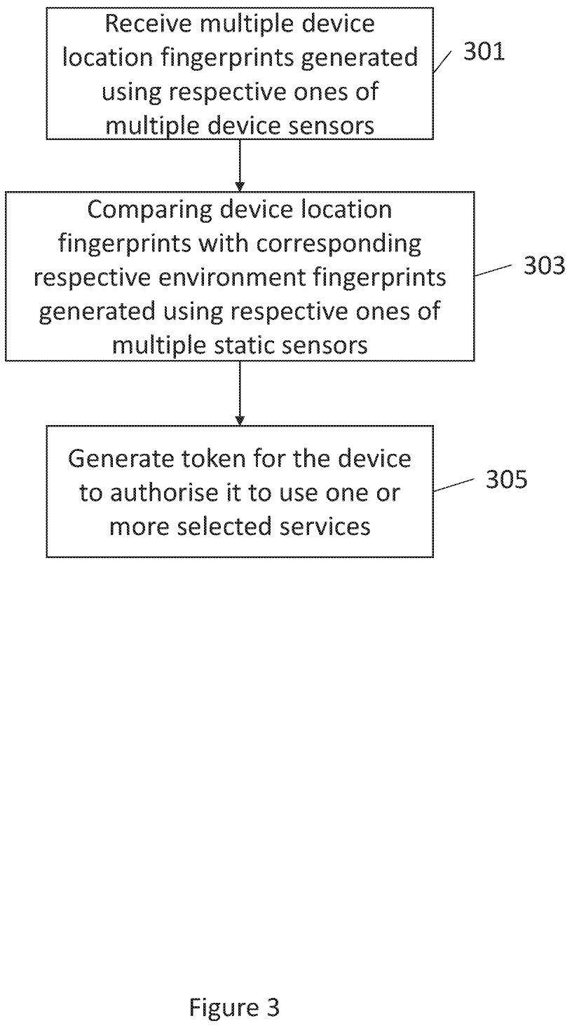

FIG. 3 is a flowchart of a method according to an example. More particularly, FIG. 3 is a flowchart of a method for location-based authentication of a device according to an example. In block 301, multiple device location fingerprints generated using respective ones of multiple device sensors are received. For example, sensors 103a-n of device 101 can respectively generate inputs for the agent 107 that can use the inputs 105a-n to generate one or more location fingerprints for device 101 based on various environmental characteristics as described above, such as IP address, temperature and so on. The output 109 of the agent 107 can be received by comparator 208 of apparatus 201. That is, in an example, comparator 208 receives data representing one or multiple location fingerprints generated by device 101.

In block 303, the device location fingerprints are compared with corresponding respective environment fingerprints generated using respective ones of multiple static sensors. That is, in an example, apparatus 201 uses respective ones of sensors 203a-n to generate inputs 205a-n representing measure for various environmental characteristics at the location where the apparatus 201 is deployed. This may be a meeting room or entrance to a shop for example. As such, the sensors 203a-n of apparatus 201 are considered static inasmuch as they are provided in a given location where it is desired to authentic mobile devices that may transiently pass through the location. In an example, apparatus may be mobile to the extent that it can be re-deployed within a given locale, e.g. from one meeting room to another, or from one side of a shop entrance to another and so on. However, when deployed, the sensors remain in place.

The output 109 from device 101 is received by apparatus 201. For example, the output 109 can be a data message comprising data representing multiple location fingerprints derived by the agent 107 of the device 101. This can be transmitted from the device 101 over a wired or wireless communication protocol (e.g. Bluetooth, wifi and so on) or near field technology. In an example, the device can broadcast the message periodically to any apparatus 201 that may be communication range. Alternatively, a user may prompt transmission when she is aware of an apparatus being in the given location. Further alternatively, the apparatus 201 may intermittently poll for such data from any devices in range. A combination of these options may be utilised.

Comparator or comparison module 209 receives the output 109 and compares the multiple location fingerprints derived by the agent 107 of the device 101 to multiple corresponding location fingerprints derived by the agent 207 of the apparatus 201. For example, apparatus 201 may comprise a set of sensors 203a-n to derive environmental data for characteristics such as those described above. A device 101 may comprises a sub-set of such sensors. Alternatively, device 101 may comprise the same sensors as apparatus 201. Each input 105a-n can include an identifier to indicate what type of measurement it relates to (e.g. temperature, image capture and so on). This can be matched to a corresponding location fingerprint generated by apparatus 201 for comparison (i.e. temperature value from device 101 is compared with temperature value from apparatus 201 and so on). This can proceed for all available location fingerprints from device 101.

In block 305, a token for the device to authorise it to use one or more selected services is generated. For example, the result of a comparison of location fingerprints can indicate that a device 101 is in the same location (e.g. room) as apparatus 201. Accordingly, apparatus 201 can issue device 101 with a token using a token generator 209, which may be a temporary token for example, to use one or more services at that location, such as a network (e.g. wifi) or a hardware apparatus (such as a projector) and so on. That is, for a device authenticated as being in the same location as the apparatus 201, a token can be provided to enable the device 101 to utilise one or more services at that location. The token generator 209 can comprise a set of tokens that can be issued to devices and which may be revoked or recycled. Alternatively, the generator 209 can generate a token for a device using data associated with the device that can be provided to the apparatus 201 by device 101, such as a device ID or cryptographic key and so on.

Examples in the present disclosure can be provided as methods, systems or machine-readable instructions. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus (for example, agents 107, 207, comparator 208, generator 209) may be implemented by a processor executing machine readable instructions stored in a memory, or a processor operating in accordance with instructions embedded in logic circuitry. The term ‘processor’ is to be interpreted broadly to include a CPU, processing unit_{;} ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

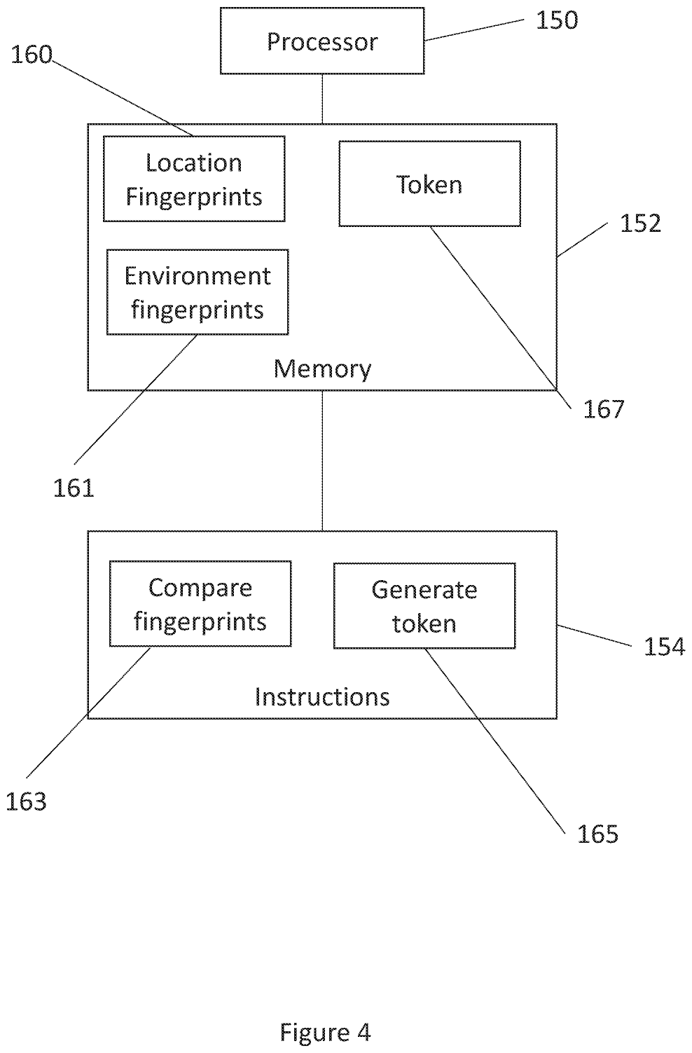

FIG. 4 shows an example of a processor 150 associated with a memory 152. The memory 152 comprises machine readable instructions 154 which are executable by the processor 150. The instructions 154 comprise instructions to:

receive multiple device location fingerprints 160 generated using respective ones of multiple device sensors;

compare 163 the device location fingerprints with corresponding respective environment fingerprints 161 generated using respective ones of multiple static sensors;

generate 165 a token 167 for the device to authorise it to use one or more selected services;

generate data representing a measure of an environmental characteristic using a device sensor;

form a location fingerprint for the device using the data representing a measure of an environmental characteristic;

applying respective identifiers to data representing the multiple device location fingerprints to indicate the basis of the fingerprint;

determine the similarity between the device location fingerprints and the environment fingerprints;

apply a tolerance to the comparison;

authenticate the device when a threshold number of device location fingerprints match with corresponding respective environment fingerprints.

Such machine-readable instructions may also be loaded onto a computer or other programmable data processing devices, so that the computer or other programmable data processing devices perform a series of operations to produce computer-implemented processing, thus the instructions executed on the computer or other programmable devices provide a operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for location-based authentication of a device_{;} the method comprising:
receiving multiple device location fingerprints generated using respective ones of multiple device sensors;
comparing the device location fingerprints with corresponding respective environment fingerprints generated using respective ones of multiple static sensors; and
generating a token for the device to authorise it to use one or more selected services.

2. A method as claimed in claim 1, further comprising:
generating data representing a measure of an environmental characteristic using a device sensor.

3. A method as claimed in claim 2, further comprising:
forming a location fingerprint for the device using the data representing a measure of an environmental characteristic.

4. A method as claimed in claim 1, further comprising:
applying respective identifiers to data representing the multiple device location fingerprints to indicate the basis of the fingerprint.

5. A method as claimed in claim 1, wherein comparing the device location fingerprints with corresponding respective environment fingerprints generated using respective ones of multiple static sensors further comprises determining the similarity between the device location fingerprints and the environment fingerprints.

6. A method as claimed in claim 1, further comprising:
transmitting the token to the device; and
using the token, accessing one or ore services in a specified location.

7. A method as claimed in claim 1, further comprising:
authenticating the device when a threshold number of device location fingerprints match with corresponding respective environment fingerprints.

8. Apparatus, comprising:
multiple sensors to generate data representing multiple environment characteristics in a location;
an agent to receive the data representing the multiple characteristics and generate respective apparatus location fingerprints; and
a comparison module to receive the apparatus location fingerprints.

9. Apparatus as claimed in claim 8, the apparatus further to:
receive data from a device representing a set of device fingerprint locations.

10. Apparatus as claimed in claim 10, the comparison module further to:
compare the set of device fingerprint locations with the apparatus location fingerprints; and
generate a measure representing similarity between the device fingerprint locations and the apparatus location fingerprints.

11. Apparatus as claimed in claim 8, further comprising:
a token generator to generate a token for a device to enable access to a service in the location.

12. A non-transitory machine-readable storage medium encoded with instructions executable by a processor for location-based authentication of a device, the machine-readable storage medium comprising instructions to:
compare a set of device location fingerprints generated using respective ones of multiple device sensors with corresponding respective environment fingerprints generated using respective ones of multiple static sensors; and
authenticate the device,

13. A non-transitory machine-readable storage medium as claimed in claim 12, further encoded with instructions to:
generate a token for the device to authorise it to use one or more selected services.

14. A non-transitory machine-readable storage medium as claimed in claim 12, further encoded with instructions to;
generate a measure representing similarity between the device fingerprint locations and the apparatus location fingerprints.

15. A non-transitory machine-readable storage medium as claimed in claim 12, further encoded with instructions to
apply respective identifiers to data representing the multiple device location fingerprints to indicate the basis of the fingerprint.
